(19) United States
(12) Patent Application Publication
(10) Pub. No.: US 2005/0076707 A1
(43) Pub. Date: Apr. 14, 2005

(54) Device and method for testing the action of liquids on surface structures

(76) Inventors: Helmut Blum, Duesseldorf (DE); Ludger Buetfering, Nideggen (DE); Roland Kraemer, Voelklingen (DE); Helmut Mueller, Duesseldorf (DE); Edmund Sabela, Duesseldorf (DE)

Correspondence Address: WOODCOCK WASHBURN LLP, ONE LIBERTY PLACE, 46TH FLOOR, PHILADELPHIA, PA, 19103, US

(21) Appl. No.: 10/918,167

(22) Filed: Aug. 13, 2004

Related U.S. Application Data
(63) Continuation of application No. PCT/EP03/01156, filed on Feb. 6, 2003.

(30) Foreign Application Priority Data
Feb. 15, 2002 (DE) 102 06 620.5

(51) Int. Cl. G01N 11/00

(52) U.S. Cl. 73/53.01

(57) ABSTRACT

Described herein are devices for the testing of the effect of liquids on one or more flat materials. In one embodiment, the device comprises a first plate having a plurality of recesses; a second plate for engaging the first plate, wherein the first and second plates are adapted to receive at least one substrate for testing therebetween, the plates defining a plurality of chambers; a drive for moving the first and second plates; and heating means, for increasing the temperature in the chambers. Methods for the testing the effect of liquids on one or more flat materials are also described.

### CROSS-REFERENCE TO RELATED APPLICATIONS

This application is a continuation of International Application PCT/EP03/01156, filed Feb. 6, 2003, which claims the benefit of German Application No. DE 102 06 620.5, filed Feb. 15, 2002, both of which are incorporated herein by reference in their entireties.

### FIELD OF THE INVENTION

The present invention relates generally to devices and methods for testing the action of liquids on surfaces.

### BACKGROUND OF THE INVENTION

It is known that the performance testing of detergents or colorants and of corrosion-inhibiting surface coatings is carried out to the actual requirements. Since corresponding practical tests always involve extensive labor- and materials-intensive, time-consuming and expensive serial tests on account of the need for statistical evaluation, special laboratory methods have to be used for informative preliminary tests and for early development work. Every effort is made to keep as close as possible to the practical conditions. The results of such methods generally provide a very good indication of the utility value. The methods are usually carried out using specially developed laboratory equipment and machines in which even small quantities of active components can be tested.

For washing tests, one such apparatus is known under the registered name of “Launderometer” of Atlas Electric. Fixed to a shaft in a housing are closable containers into each of which a sample of the wash liquor and a sample of the soiled textile can be introduced. To carry out the test, the shaft is rotated, so that the wash liquor moves, and the containers are externally heated. A temperature of at least 30 to 40° C.—achieved by external heating—has to be established in the containers. However, the containers, which typically have a volume of 100 to 200 ml, take a relatively long time to be heated so that the tests are correspondingly long in duration. Another disadvantage is the small number of containers. In conjunction with the long heating time, this leads to a low throughput of samples per unit of time. Another disadvantage is that the tests carried out with the described test apparatus cannot be automated and integrated into a unit for automatically testing the washing results.

### SUMMARY OF THE INVENTION

In certain aspects, the invention relates to an apparatus for testing the effect of liquids on one or more flat materials. Additional aspects of the present invention relate to a process for the testing the effect of liquids on one or more flat materials and to the use of the apparatus according to the invention. Other features and advantages of the present invention will be understood by reference to the detailed description and the examples that follow.

### BRIEF DESCRIPTION OF THE DRAWINGS

FIG. 1 is a plan view of an apparatus in accordance with an embodiment of the present invention.

FIG. 2 is a section on the line II-II in FIG. 1, in accordance with an embodiment of the present invention.

FIG. 3 schematically illustrates a test fabric used in the apparatus shown in FIGS. 1 and 2, in accordance with an embodiment of the present invention.

FIG. 4 is graph illustrating the test results obtained with the apparatus in a series of washing tests, in accordance with an embodiment of the present invention.

FIG. 5 shows the results obtained with the apparatus in the testing of a corrosion inhibitor as a function of concentration in a corrosion test on a steel plate, in accordance with an embodiment of the present invention.

### DETAILED DESCRIPTION OF ILLUSTRATIVE EMBODIMENTS

Before describing the invention in detail, it should be understood that this invention is not limited to the particular parameters as described in the specification for these parameters may of course vary. It is to be further understood that the terminology used herein is for the purpose of describing particular embodiments of the invention only, and is not intended to limit the scope of the invention in any manner.

All numerical ranges described herein include all combinations and subcombinations of ranges and specific integers encompassed therein.

In certain aspects, a problem addressed by the present invention was to provide an apparatus of the type mentioned at the beginning which would allow a high throughput per unit of time and integration into an automated test system with simultaneous automatic evaluation of the test results. Finally, the great potential of combinatorial chemistry may also be realized for the development of new formulations.

According to an embodiment of the present invention, the solution to this problem is characterized in that the apparatus is designed in such a way that liquids can be heated by more than 1° C./s inside the chambers of the apparatus.

Accordingly, one embodiment of the present invention relates to an apparatus for the simultaneous testing of the effect of liquids on one or more flat materials which comprises at least one coherent element or plate with a plurality of chambers, a cover or second plate for closing the chambers and a drive for moving the element and which is characterized in that the liquids can be uniformly heated by more than 1° C./s in the chambers.

This property can be achieved by one or more technical features of the apparatus. Firstly, the overall volume of liquid in the chambers can be reduced by miniaturization. This smaller volume of liquid requires less heating energy so that greater heating can be achieved for the same input of energy. In the case of radiation heat, for example by a heating cabinet or a heating bath, the reduction in the size of the chambers has a further advantage. Through the increasing ratio of chamber wall surface to liquid volume, the area of exchange with the ambient environment increases, which is reflected in an increased input of heat into the chambers. This effect is particularly in evidence when the apparatus and particularly the chamber walls is/are made of a material heatable by microwaves. In this case, the liquid is heated indirectly through the heating chamber walls and—if the liquid absorbs microwaves—directly by the microwave radiation. This particularly rapid heating provides for a greatly increased sample throughput. In addition, tests where a long heating phase invalidates the test result can also be carried out with this apparatus. Thus, in the event of slow heating of a bleaching solution, part of the oxidizing agent decomposes before the desired temperature is reached, so that exact determination is not possible.

In one embodiment of an apparatus according to the invention, the cover consists of an element which optionally comprises a plurality of chambers and which can be releasably connected to the element. This is of advantage because simple and rapid handling is guaranteed by the releasable connection of the two elements.

In a preferred embodiment of an apparatus according to the invention, the chambers can be closed or opened in only a single step. This is particularly advantageous because considerable time is saved in the handling of samples.

Virtually any number of chambers can be provided in the apparatus according to certain aspects of the invention, so that sample throughput can be increased accordingly. The chambers thus formed can be opened or closed in a single step by opening and closing of the plates, which is suitable for the use of robots for automating the test procedure.

An apparatus according to an embodiment of the invention may be used for testing detergent formulations or individual components for their effect on soiled textiles and for testing metal plates or their coatings, for example for testing corrosion behavior, and for testing other flat materials. In addition, the apparatus according to an embodiment of the invention may also be used in coloring tests, for example for textiles or hair.

In one preferred embodiment of an apparatus according to the invention, the two elements designed to be placed on one another comprise one or more corresponding recesses. This is particularly advantageous because the apparatus can thus be adapted to meet various requirements. Thus, flat materials can be contacted with liquids partly on one side and on two sides.

In a particularly preferred embodiment of an apparatus according to the invention, the two elements designed to be placed on one another comprise corresponding recesses. To this end, it is of particular advantage to position the flat material between the elements in the vicinity of the recesses. The liquid to be tested then wets the flat material from both sides which is particularly advantageous in the case of flat materials that are substantially permeable to the liquid, such as textile materials for example. In addition, particularly simple, automatable insertion of the flat material to be tested is possible. To increase the exchange of liquid between the chamber segments divided up by the flat material, it can be of advantage to make a small hole in the flat material in the wetted region. However, this hole should not significantly reduce the surface area of the flat material.

A particular advantage of the apparatus according to one embodiment of the invention is that a number of tests can be carried out at the same time. To carry out such parallel tests, the apparatus has at least 6, preferably more than 25 and, more particularly, more than 50 recesses in the elements. Apparatus with a larger number of recesses are also possible, the only limiting factor here being the space taken up by the apparatus. For example, two such apparatus could be fixed to one another in “mirror-inverted” fashion, enabling capacity to be doubled without, at the same time, significantly increasing the space required. The cross-section of the recesses may be substantially round, rectangular, above all square, or triangular. It can also be of advantage to use recesses with 6, 7, 8 or more corners. Thus, a honeycomb structure affords advantages in regard to mechanical stability or reducing wall thickness for the same stability.

In another embodiment of the invention, recesses of different kinds are present in one and the same plate. The recesses may differ in shape and/or size.

In one particularly preferred embodiment of an apparatus according to the invention, the flat material is arranged between the element and the cover in the vicinity of the recesses. In this embodiment, the flat material may itself represent the substrate to be tested or may act as a mechanical carrier not involved in a possible reaction. In the second case, individual metal samples in the form of small plates may be fixed to a carrier plate. The carrier plate should be made of a material which does not show any reaction under the proposed test conditions. If small metal plates of different materials are to be tested, the carrier plate should consist of an electrically conductive material to suppress the development of local elements between the individual cells which could result in invalidation of the test results. In the interests of easier handling, the diameter of the individual metal plates is advantageously smaller than the diameter of the individual chambers. This structure has the particular advantage that not only can various corrosive liquids be tested for their effect on a material, different materials or differently coated materials can also be simultaneously tested so that considerable time can be saved.

In another particularly preferred embodiment of an apparatus according to the invention, the chambers are designed in such a way that they have a volume of less than 100 ml. This small chamber volume has the advantage that a smaller quantity of chemicals can be used so that the costs involved in the chemicals and their disposal are reduced. In addition, a reduction in chamber volume means a higher heating rate, as described in the foregoing. At the same time, a smaller chamber size reduces the space required for each individual experiment. In this way, more parallel tests can be carried out for the same space requirement. The chambers can even be made with volumes smaller than 50 ml or even smaller than 10 ml.

In another preferred embodiment, an apparatus according to the invention comprises a heating unit. This heating unit may be, for example, a laboratory heating cabinet or a heating bath.

In a particularly preferred embodiment, an apparatus according to the invention comprises a microwave heating unit. This has the advantage that the liquids in the apparatus can be heated particularly rapidly by such a unit.

To achieve particularly rapid heating of the liquids to be tested, preferably the elements or plates to consist of a non-metallic material and, more particularly, a plastic. In this way, the plates can be arranged inside a microwave unit which heats the liquids to be tested. In this case, the drive for moving the plates should be arranged outside the microwave unit and connected by a shaft to the plates arranged inside the microwave unit.

In a particularly preferred embodiment, the elements or plates consist of a material heatable by microwave radiation. In this case, heating to the required temperature is achieved particularly quickly and the required temperature is reliably maintained for a particularly long time. One example of such a material is the graphite-containing PTFE plastic known by the name of “Weflon”

In addition, a device for measuring temperature may be arranged inside at least one chamber. The temperature in the chamber can thus be monitored. If an electronic temperature sensor (for example a thermocouple or a temperature-dependent resistance) is used for measuring temperature, the measuring signal emitted by the temperature sensor may be used to control the heating level.

In another preferred embodiment, the cover is the flat material. This is particularly advantageous when liquids are to be tested for their effect on a single, more particularly flat and liquid-impermeable substrate. This reduces the effort involved in handling because only one element and the flat material have to be placed on one another. This embodiment may be used, for example, in corrosion tests on metallic materials (see also Example 2).

In certain aspects, the present invention also relates to a process for simultaneously testing liquids for their effect on flat materials using the apparatus according to the invention described in the foregoing, characterized in that a flat material is placed on an element and the effect of the liquids on the flat material is analyzed in the region of the recesses.

An additional aspect of the present invention relates to a process for simultaneously testing liquids for their effect on flat materials using the apparatus according to the invention, characterized in that a flat material is placed between the elements and the effect of liquids is analyzed in the region of the recesses. The effect on the flat material can be determined, for example, by optical evaluation methods during or after the contact time. If the progressive effect is to be observed during the test, at least one of the two elements should preferably be made of a transparent material or provided with transparent materials in the region of the recesses or at the bottom of the chambers. Glass or various transparent plastics, such as Plexiglas® for example, may be used as the transparent materials. The optical analysis is then made via a digital camera which, preferably, covers all flat materials optically in one image. Continuous discoloration of the flat materials can be evaluated by computer. This evaluation may also be completed by online image series, the chronological test sequence being recorded by repeated shots.

If evaluation is to be carried out by the optical method described above, this presupposes a change in the color as a function of time. In the testing of various detergents for their cleaning effect on cotton stained with red wine, a good cleaning effect is indicated by complete decoloration of the red wine stain. In the testing of coloring compositions on cotton or in the testing of hair dyes, good results are indicated by intensive colors. Finally, in the testing of corrosion-inhibiting layers, for example on phosphated steel plates, samples with relatively poor corrosion resistance can be recognized by the appearance of rust specks. Suitable color indicators may even be used in cases where the reaction to be investigated does not itself initiate any discoloration or is difficult to discern. Thus, metal ions released during corrosion tests can be colored by suitable indicators and thus made accessible to optical measurement.

Certain aspects of the present invention also relate to the use of the apparatus according to the invention for testing liquids for their effect on flat materials in washing, coloring or corrosion tests.

According to certain aspects of the invention, devices and methods are provided for testing the large number of compounds produced by combinatorial chemistry in tests simulating practical conditions. Accordingly, certain aspects of the present invention also relate to the use of the apparatus according to the invention for high-throughput screening, particularly in the context of combinatorial chemistry.

One example of an embodiment of the invention is described in detail in the following with reference to the accompanying drawings, wherein:

FIG. 1 is a plan view of an apparatus according to an embodiment of the invention.

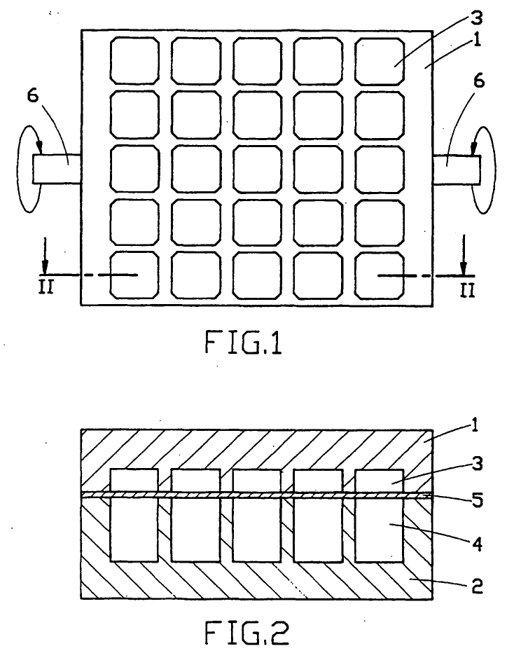

FIG. 2 is a section on the line II-II in FIG. 1.

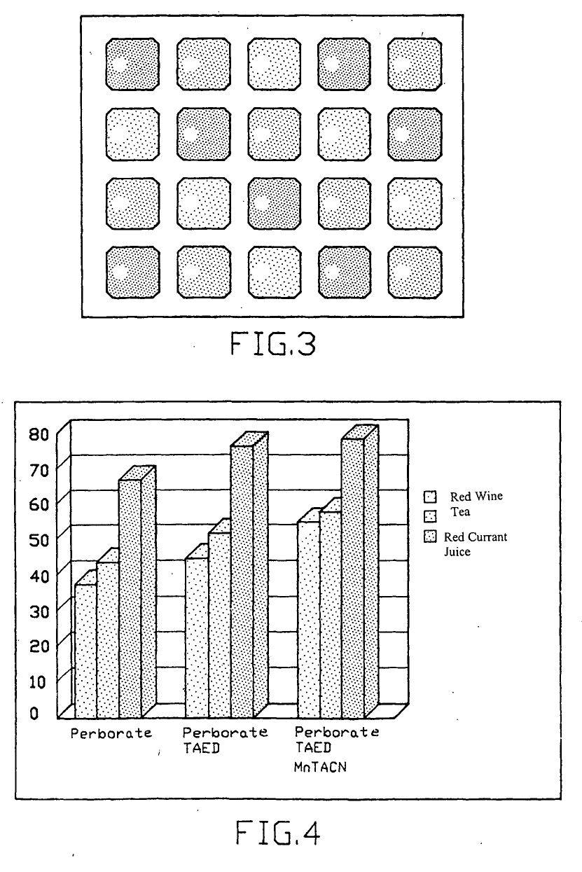

FIG. 3 schematically illustrates a test fabric used in the apparatus shown in FIGS. 1 and 2.

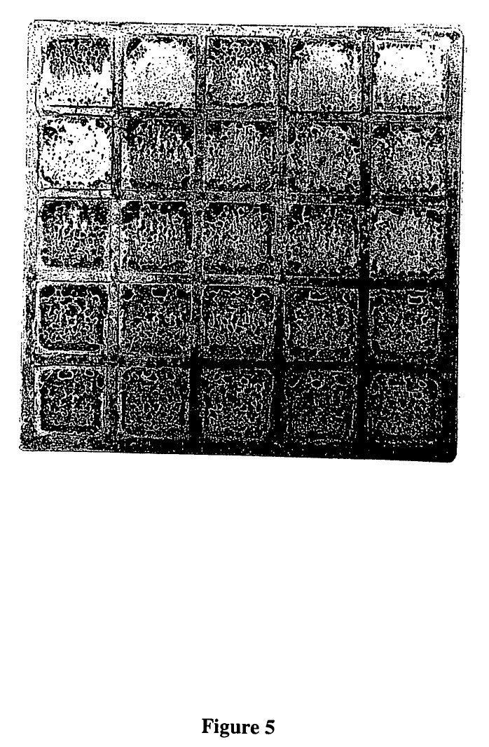

FIG. 4 is graph illustrating the test results obtained with the apparatus in a series of washing tests.

FIG. 5 illustrates the results obtained with the apparatus in a corrosion test on a steel plate with a corrosion inhibitor tested as a function of concentration.

With the apparatus according to an embodiment of the invention, 25 conventional washing experiments can be simulated over an area of 200 cm². The apparatus can be automated and integrated into a screening unit of a combinatorial laboratory using robots. The miniaturized apparatus provides for a high sample throughput per unit of time.

According to one embodiment of the invention, the core of the apparatus schematized in FIGS. 1 and 2 consists of two plates: a second plate (cover) 1 and a first plate 2 which form two halves of a Plexiglas body. In each of these plates, there are 25 recesses 3,4, the upper recesses 3 and the lower recesses 4 lying exactly in line one above the other in the assembled state and thus forming the chambers in which the experiments are carried out. In the illustrated embodiment, each of the chambers has a volume of 16 ml, the upper recess 3 having a volume of 4 ml and the lower recess 4 a volume of 12 ml.

The flat material 5—in the example, a test fabric—is held between the two plates 1,2.

The two plates 1, 2 can be held together by screws or preferably by clips which, in the interests of clarity, has not been shown in the drawings. In addition, grooves for accommodating a seal are also preferably formed at the edge of the recesses 3, 4.

The length and width of the recesses 3, 4, which are substantially square in cross-section, is 1.8 cm. The plates 1, 2 are substantially square with an edge length of about 15 cm. The total height in the assembled state shown in FIG. 2 is ca. 8 cm.

For rotation, the plates 1, 2 are connected by a shaft 6 to a geared motor (not shown in the drawings). The shaft 6 also serves as suspension.

Throughout the duration of the test, the apparatus according to the invention is rotated at a constant speed—16 r.p.m. in the example. Other rotational speeds are possible.

Since the washing tests are normally carried out at a predetermined temperature of 25 to 40° C., the test arrangement is preferably heated. To this end, the apparatus may be placed in a conventional laboratory heating cabinet. The test solutions may optionally be preheated before they are introduced into the apparatus. The heating facility is also of use for coloring experiments or corrosion tests.

With greater advantage, because it is quicker and less expensive, heating can be carried out by using a microwave system, for example a conventional laboratory microwave cabinet. The test temperature can be reached very quickly in this way, so that there is no need in this case for preheating of the equipment and solutions used. Temperature is advantageously measured by a probe in one of the 25 chambers 3, 4. On account of the connecting cable of the temperature probe, the apparatus is not continuously rotated in this case, but instead is only moved back and forth through an angle of 180°. Another advantageous method of measuring the temperature is to record the temperature by an external sensor, for which purpose the chamber can again be turned upside down.

In addition, in order to increase the mixing effect, it is possible and of advantage to charge the chamber formed by the recesses 3 and 4 with 5 to 20 and preferably with 5 to 10 glass, metal or plastic balls. This is particularly advantageous when viscous liquids, such as hair coloring formulations for example, are present in the chambers.

### EXAMPLES

The following examples illustrate the invention, but without restricting it thereto.

### Example 1

One example of a detergent screening test using the apparatus according to the invention is described in the following and illustrates the outstanding suitability of the apparatus according to the invention for carrying out washing tests:

Test conditions: temperature 30° C.
test duration 20 mins.
10.5 ml wash liquor in each of the 25 chambers

The prepared and heated wash liquors containing the detergents or bleaching agents were introduced into the lower recesses 4. In the case of an automated apparatus, the prepared wash liquors are introduced into the recesses by a robot. The test fabric was placed on the plate with the recesses (4) and the other plate was in turn placed on the test fabric. Finally, the two plates 1, 2 were screwed together and connected to the drive.

The tea-stained test fabric (FIG. 3) was provided with small holes so that the wash liquor was able to pass through the fabric from both sides. The test fabric was thus strongly bleached on both sides.

The fabric swatches were evaluated by a scanner in conjunction with special software (Bio-Scan). The test fabric was scanned before the test and after bleaching and the percentage bleaching performance was determined from the different optical densities. Another possibility is to characterize the bleaching performance with a chromatometer (for example “Chroma Meter Cr-200”, Minolta). In this case, the bleach-catalytic activity is again determined via the color density. In addition, measurement of the color vectors can be carried out automatically using a robot-controlled optical fiber spectrometer.

FIG. 4 shows the test results obtained with the apparatus according to the invention against a red wine stain. These test results represent the decoloration values for test fabric soiled with red wine (left-hand bar), tea (middle bar) and red currant juice (right-hand bar) after bleaching with the agents mentioned at the bottom of FIG. 4. Differentiation of the bleaching performance is clearly discernible.

### Example 2

The effect of a corrosion inhibitor on the corrosion of St 04 steel in (synthetic) sea water is investigated in the following Example. The results are shown in FIG. 5. The tests were carried out in an apparatus with 25 recesses arranged in a 5×5 matrix. The recesses are filled with synthetic sea water at 60° C. and a corrosion inhibitor (Lubrizol 9530 T, BASF) is added in 5 different concentrations. Five recesses in the same row were filled with the same solution.

Lubrizol 9530 T Remarks

Row 1 1000 ppm (FIG. 5, top)

Row 2 300 ppm Max. value recommended by manufacturer

Row 3 200 ppm

Row 4 150 ppm

Row 5 100 ppm (FIG. 5, bottom)

The steel plate was cleaned and degreased in an alkaline cleaning bath (Ridoline 1559, Henkel). The plate was immersed for 10 minutes in the cleaning bath heated to 60° C., rinsed with tap water, washed with deionized water and dried with compressed air. Immediately before use, the plate was cleaned with ATA liquid and then rinsed with deionized water.

The steel plate was placed on the element (2) filled as described above. The two parts were screwed together, placed in a laboratory oven at 60° C. and connected to the drive. The steel plate was then left for 3 hours at T=60° C. and at 60 r.p.m. The steel plate was then removed, carefully washed with deionized water, dried with compressed air and photographed. FIG. 5 shows a plate where the corrosion-inhibiting effect of the Lubrizol 9530 T in a concentration of up to 300 ppm (2nd row from the top) is clearly reflected in the relatively slight formation of rust. Higher concentrations of inhibitor (1,000 ppm, upper row) produce hardly any improvement. Accordingly, the optimal quantity of inhibitor can be determined in a short time with the apparatus according to the invention with little outlay on material and chemicals.

List of Reference Numerals

1 plate, second element (cover)

2 plate, first element

3 recess

4 recess

5 flat material

6 shaft

Various modifications of the invention, in addition to those described herein, will be apparent to those skilled in the art from the foregoing description. Such modifications are also intended to fall within the scope of the appended claims.

1. An apparatus, comprising:
a first plate having a plurality of recesses;
a second plate for engaging the first plate, wherein the first and second plates are adapted to receive at least one substrate for testing therebetween, the plates defining a plurality of chambers;
a drive for moving the first and second plates; and
heating means, for increasing the temperature in the chambers.

2. The apparatus of claim 1, wherein the chambers contain liquids for testing.

3. The apparatus of claim 1, wherein the second plate has a plurality of recesses.

4. The apparatus of claim 3, wherein the second plate has a plurality of recesses aligning with those of the first plate.

5. The apparatus of claim 1, wherein liquids in the chambers can be uniformly heated by more than 1° C./s.

6. The apparatus of claim 1, wherein the second plate comprises an element releasably connected to the first plate.

7. The apparatus of claim 1, wherein the drive axially rotates the first and second plates.

8. The apparatus of claim 1, wherein the first plate and the second plate each comprise at least six recesses.

9. The apparatus of claim 1, wherein the first plate and the second plate each comprise at least 25 recesses.

10. The apparatus of claim 1, wherein the first plate and the second plate each comprise at least 50 recesses.

11. The apparatus of claim 1, wherein the chambers each hold a volume of less than 100 ml.

12. The apparatus of claim 1, wherein the heating means comprise a microwave heating unit.

13. The apparatus of claim 1, wherein the first plate and second plate are of a non-metallic material.

14. The apparatus of claim 13, wherein the non-metallic material is plastic.

15. The apparatus of claim 1, wherein the first plate and second plate are of a material heatable by microwave radiation.

16. The apparatus of claim 1, further comprising a temperature measuring device disposed in at least one chamber.

17. An apparatus, comprising:
a first plate having a plurality of recesses;
a second plate for engaging the first plate, the plates defining a plurality of chambers, wherein the second plate acts as a substrate for testing the effect of liquids placed in the chambers;
a drive for moving the first and second plates; and
heating means, for increasing the temperature in the chambers.

18. A process for simultaneously testing liquids for their effect on flat materials comprising the steps of:
inserting at least one flat material between the first and second plates of the apparatus of claim 1;
placing liquids within the chambers of the apparatus; and
analyzing the effect of the liquids in the region of the chambers of the apparatus.

19. A process for simultaneously testing the effect of liquids comprising the steps of:
placing liquids within the chambers of the apparatus of claim 17; and
analyzing the effect of the liquids on the second plate in the region of the chambers of the apparatus.

20. The process of claim 18 wherein the liquids are tested for their effect on washing, coloring or corrosion of the flat material.

21. The process of claim 18 wherein the liquids are tested by high-throughput screening.
